(19) United States
(12) Patent Application Publication
(10) Pub. No.: US 2009/0098817 A1
(43) Pub. Date: Apr. 16, 2009

(54) Air conditioner for vehicle

(75) Inventor: Junji Goto, Handa-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/286,520

(22) Filed: Sep. 30, 2008

(30) Foreign Application Priority Data
Oct. 10, 2007 (JP) 2007-264770

(51) Int. Cl. B60H 1/26

(52) U.S. Cl. 454/145

(57) ABSTRACT

A vehicle air conditioner includes a drive device for adjusting open degrees of mode doors, and a control portion which controls operation of the drive device. Air-outlet opening portions include a face opening portion for blowing conditioned air toward an upper side of a passenger compartment, and a foot opening portion for blowing conditioned air toward a lower side of the passenger compartment. The mode doors include a face mode door for opening and closing the face opening portion, and a foot mode door for opening and closing the foot opening portion. The control portion is configured to perform a mode switching control in which the open degrees of the mode doors are adjusted based on an air outlet mode, and to perform a fluctuation control in which at least one of the face mode door and the foot mode door is increased or decreased in a predetermined range.

### CROSS REFERENCE TO RELATED APPLICATION

This application is based on Japanese Patent Application No. 2007-264770 filed on Oct. 10, 2007, the contents of which are incorporated herein by reference in its entirety.

### FIELD OF THE INVENTION

The present invention relates to an air conditioner for a vehicle, which can perform a fluctuation control in air conditioning of a passenger compartment of the vehicle.

### BACKGROUND OF THE INVENTION

Recently, a vehicle air conditioner is required to adjust a temperature of a passenger compartment while improving a comfortable property for a passenger in the passenger compartment. For example, in a case where a comfortable temperature for a passenger is kept in the passenger compartment, if a certain air amount is continuously blown to the body of the passenger, the comfortable property for the passenger is reduced.

In a vehicle air conditioner described in JP-A-2005-112231, a swing louver is provided in an air outlet so as to adjust a flow direction of air blown from the air outlet. In the vehicle air conditioner, the air amount blown to the body of the passenger is regularly changed by changing the flow direction of air blown from the air outlet, so that the comfortable property for the passenger in the passenger compartment is improved.

However, in the above vehicle air conditioner, it is necessary to locate a special actuator for driving the swing louver, at each air outlet, thereby increasing the cost.

### SUMMARY OF THE INVENTION

In view of the foregoing problems, it is an object of the present invention to provide an air conditioner for a vehicle, which can improve comfortable property for a passenger in a passenger compartment while reducing the cost.

According to an aspect of the present invention, an air conditioner for a vehicle includes air-outlet opening portions, mode doors, a drive device configured to adjust open degrees of the mode doors, and a control portion which controls operation of the drive device. The air-outlet opening portions include a face opening portion through which conditioned air is blown toward an upper side of a passenger compartment of the vehicle, and a foot opening portion through which conditioned air is blown toward a lower side of the passenger compartment of the vehicle. The mode doors include a face mode door configured to open and close the face opening portion, and a foot mode door configured to open and close the foot opening portion. Furthermore, the control portion controls operation of the drive device to perform a mode switching control in which the open degrees of the mode doors are adjusted based on an air outlet mode, and to perform a fluctuation control in which at least one of the face mode door and the foot mode door is increased or decreased in a predetermined range.

Because a flow amount of the conditioned air blown from at least one of the face opening portion or the foot opening portion can be changed by fluctuation in the air outlet mode, comfortable property for a passenger in the passenger compartment can be improved. Furthermore, because the fluctuation control for changing the flow amount of the conditioned air can be performed by increasing or decreasing the open degree of the face mode door or the foot mode door, the vehicle air conditioner with the fluctuation control can be manufactured without increasing the cost.

For example, the drive device may include a link mechanism configured to adjust the open degree of one of the face mode door or the foot mode door while closing the other one of the face mode door or the foot mode door, and an actuator configured to drive and operate the link mechanism. Thus, when the fluctuation control is performed for the one of the face mode door and the foot mode door, it can prevent a leakage of conditioned air via the other one of the face mode door and the foot mode door.

The actuator may have at least first to fifth drive angles in this order when being rotated in one direction. In this case, the link mechanism may be configured to change the open degree of the face mode door while substantially closing the foot mode door when a rotation angle of the actuator is changed from the first drive angle to the second drive angle, configured to open the face mode door and to substantially close the foot mode door when the rotation angle of the actuator is at the third drive angle, configured to open both the face mode door and the foot mode door when the rotation angle of the actuator is at the fourth drive angle, and configured to substantially close the face mode door and to open the foot mode door when the rotation angle of the actuator is at the fifth drive angle. Furthermore, the control portion may be configured to perform the fluctuation control by changing the rotation angle of the actuator in a range between the first drive angle and the second drive angle.

For example, the air-outlet opening portions may further include a defroster opening portion through which conditioned air is blown toward an inner surface of a windshield of the vehicle, and the mode doors may further include a defroster mode door configured to open and close the defroster opening portion. In this case, the control portion controls the operation of the drive device to perform the mode switching control in which the open degrees of the face mode door, the foot mode door and the defroster mode door are adjusted based on the air outlet mode, and to perform the fluctuation control in which at least one of the face mode door and the foot mode door is increased or decreased in the predetermined range.

The air conditioner may be provided with a temperature adjustment portion provided upstream of the air-outlet opening portions so that the conditioned air having a desired temperature is blown into the passenger compartment through at least one of the air-outlet opening portions in a set air outlet mode. In this case, the control portion may be configured to perform the fluctuation control while the conditioned air having the desired temperature is blown into the passenger compartment in the set air outlet mode.

Furthermore, the link mechanism may be configured such that the mode doors are operatively linked with each other through the link mechanism.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a schematic sectional view showing a vehicle air conditioner according to an embodiment of the invention;

FIG. 2 is a schematic view showing a drive device for driving a defroster mode door, a face mode door and a foot mode door according to the embodiment;

FIG. 3 is a graph showing one example of the relationship between an actuator drive angle and mode door angle in the embodiment; and

FIG. 4 is a schematic diagram showing a state where a fluctuation control of a flow amount of conditioned air blown into a passenger compartment via a face opening portion is performed.

### DETAILED DESCRIPTION OF THE PREFERRED EMBODIMENTS

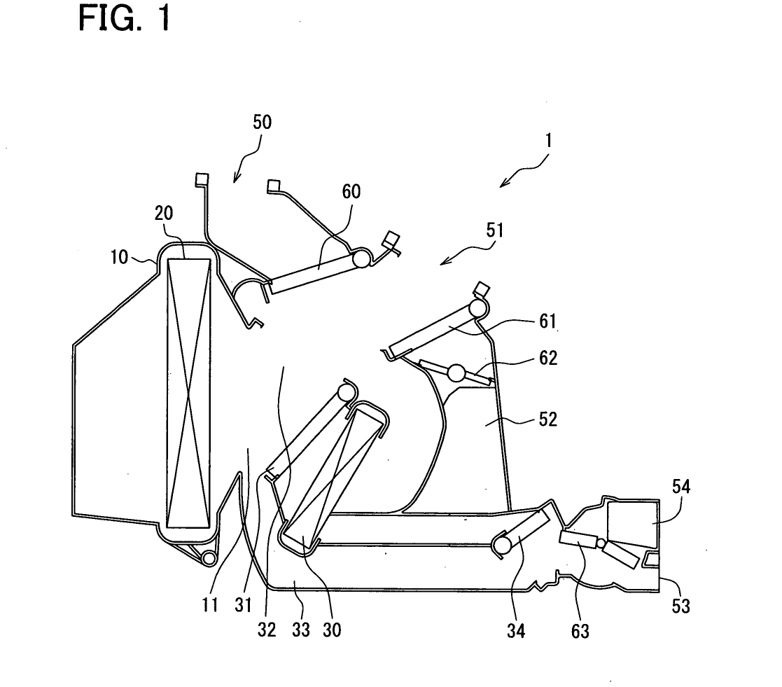

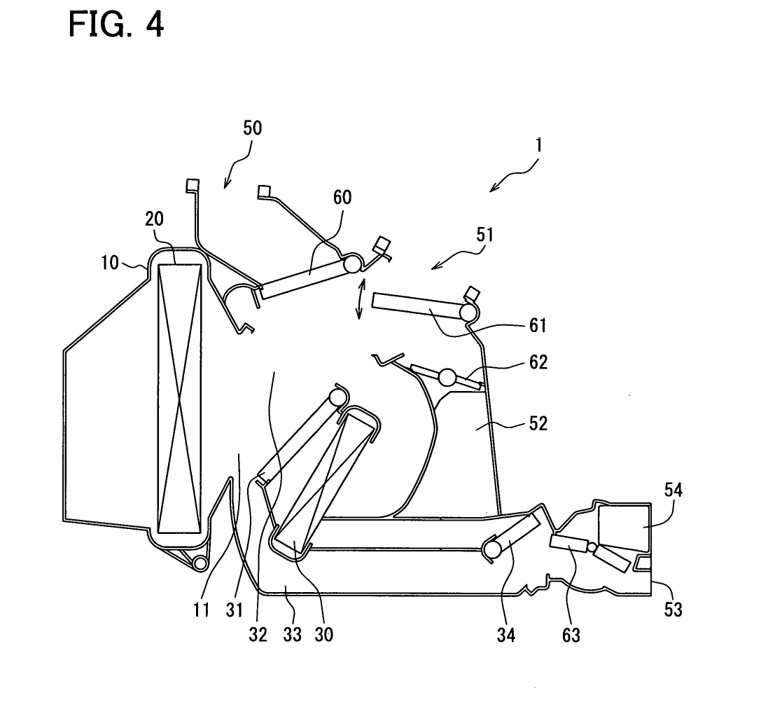

A vehicle air conditioner 1 according to an embodiment of the present invention will be described with reference to FIGS. 1 to 4.

As shown in FIG. 1, the vehicle air conditioner 1 includes an air conditioning case 10 which defines therein an air passage 11 through which air flows into a passenger compartment of the vehicle. The air conditioning case 10 is located in a passenger compartment of the vehicle inside a dashboard (instrument panel) located at a front portion in the passenger compartment. The air conditioner is provided with a blower unit (not shown), which selectively switches inside air (i.e., air inside the passenger compartment) or/and outside air (i.e., air outside the passenger compartment) to be introduced therein, and blows the introduced air into the air passage 11 so as to generate an air flow toward the passenger compartment.

A refrigerant evaporator 20 is located in the air passage 11 of the air conditioning case 11 at a downstream air side of the blower unit. The refrigerant evaporator 20 cools air passing therethrough by performing heat exchange flowing therein and air passing through. The refrigerant evaporator 20 is a component of a refrigerant cycle in which refrigerant circulates. The refrigerant is evaporated in the refrigerant evaporator 20 by absorbing heat from air so that air passing through the refrigerant evaporator 20 is dehumidified and cooled.

A heater core 30 for heating air by using engine coolant as a heat source is located downstream of the refrigerant evaporator 20 in an air flow direction. Therefore, the heater core 30 heats cool air after passing through the refrigerant evaporator 20. The heater core 30 is located in the air conditioning case 11 to form a front bypass passage 32 through which air flows into the front seat area while bypassing the heater core 30. The front bypass passage 32 is provided in the air passage 11 above the heater core 30. An air mixing door 31 is located between the refrigerant evaporator 20 and the heater core 30 to adjust a ratio between a flow amount of air passing through an upper portion in the heater core 30 and a flow amount of air passing through the front bypass passage 32. Therefore, the temperature of air to be blown toward the front area in the passenger compartment is adjusted. The air mixing door 31 is driven by a driving portion (not shown) so that a rotation position of the air mixing door 31 can be adjusted, thereby obtaining conditioned air having a desired temperature.

A rear bypass passage 33 through which air from the refrigerant evaporator 20 flows toward a rear seat area in the passenger compartment while bypassing the heater core 30 is provided in the air passage 11 of the air conditioning case 10 at a position lower than the heater core 30. A rear air mixing door 34 is located at a downstream air portion of the rear bypass passage 33, to adjust a ratio between a flow amount of air flowing through a lower portion in the heater core 30 and a flow amount of air flowing through the rear bypass passage 33. Therefore, conditioned air having a desired temperature can be blown toward the rear seat area in the passenger compartment.

A defroster opening portion 50, a face opening portion 51 and a foot opening portion 52 are provided downstream of the upper portion in the heater core 30 and the bypass passage 32. The defroster opening portion 50 is provided so that conditioned air having temperature-adjusted by the front air mixing door 31 is blown from the defroster opening portion 50 toward an inner surface of a windshield. The face opening portion 51 is provided so that conditioned air having temperature-adjusted by the front air mixing door 31 is blown from the face opening portion 50 toward the upper area of a passenger in a front seat in the passenger compartment. The foot opening portion 52 is provided so that conditioned air having temperature-adjusted by the front air mixing door 31 is blown from the foot opening portion 52 toward the lower area (foot area) of the passenger in the front seat in the passenger compartment.

The defroster opening portion 50, the face opening portion 51 and the foot opening portion 52 are opened and closed, respectively, by the defroster mode door 60, the face mode door 61 and the foot mode door 62, based on an air outlet mode that is selected automatically or manually. FIG. 1 shows a face mode in which the defroster opening portion 50 is closed by the defroster mode door 60, the face opening portion 51 is opened by the face mode door 61, and the foot opening portion 52 is closed. The defroster mode door 60, the face mode door 61 and the foot mode door 62 are driven and rotated by a drive device 140 in accordance with control of a control portion 130 (ECU). In the example shown in FIG. 1, When the face mode door 61 fully opens the face opening portion 51, the foot opening portion 52 is closed by the face mode door 61.

A rear face opening portion 53 and a rear foot opening portion 54 are provided in the air conditioning case 10 at a downstream air side of the rear air mixing door 34. The rear face opening portion 53 and the rear foot opening portion 54 are opened and closed by a rear mode door 63 based on a rear air outlet mode selected automatically or manually. FIG. 1 shows a state of the rear face mode in which the rear face opening portion 53 is opened and the rear foot opening portion 54 is closed.

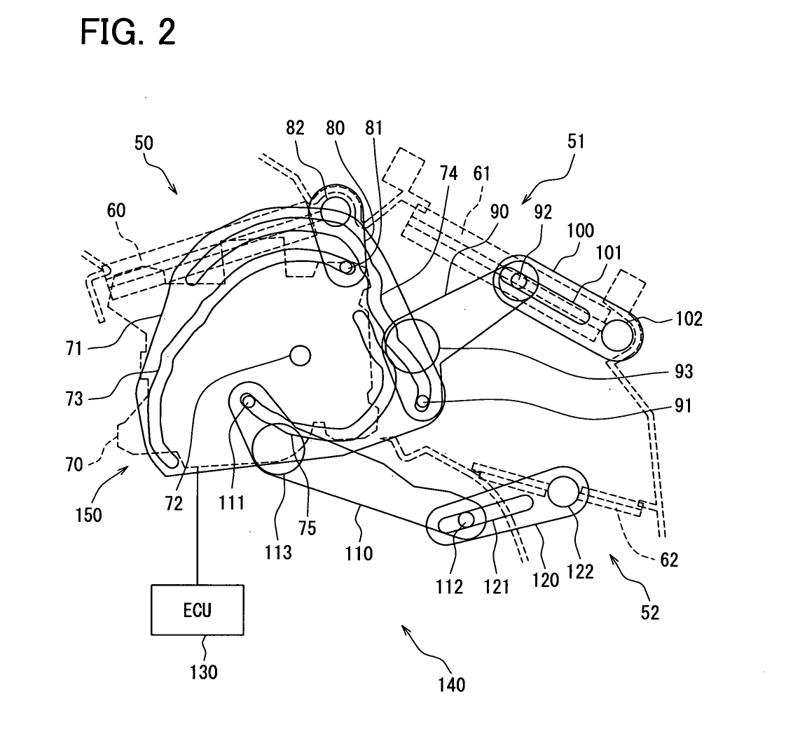

FIG. 2 is a schematic diagram showing a structure of the drive device 140 for driving and rotating mode doors such as the defroster mode door 60, the face mode door 61 and the foot mode door 62. As shown in FIG. 2, the drive device 140 includes an actuator 70 and a link mechanism 150. The actuator 70 is configured to normally or reversely rotate its rotation shaft by predetermined angles, and the link mechanism 150 is configured to transmit the driving force of the actuator 70 to the mode door(s) 60, 61, 62. The rotation angle of the actuator 70 is controlled by the control portion 130.

The link mechanism 150 includes a link plate 71 formed into a predetermined shape. A bearing hole portion 72 into which the rotation shaft of the actuator 70 is connected is formed in the link plate 71, approximately at a center area of the link plate 71. Three guide grooves 73, 74, 75 extending on a side surface of the link plate 71 around the bearing hole portion 72 are provided.

A convex guide pin 81 is provided at one end portion of the link lever 80 to be slidably inserted and moved in the guide groove 73. The other end portion of the link lever 80 is connected to a rotation shaft 82 of the defroster mode door 60.

A convex guide pin 91 is provided at one end portion of the link lever 90 to be slidably inserted and moved in the guide groove 74. The other end portion of the link lever 90 is provided with a convex guide pin 92. A rotation shaft 93 is provided in the link lever 90 between the guide pin 91 and the guide pin 92. The guide pin 92 is slidably inserted and moved in a straight guide groove 101 extending from one end portion of a link lever 100, and a rotation shaft 102 of the face mode door 61 is connected to the other end of the link lever 100.

A convex guide pin 111 is provided at one end portion of the link lever 110 to be slidably inserted and moved in the guide groove 75. The other end portion of the link lever 110 is provided with a convex guide pin 112. A rotation shaft 113 is provided in the link lever 110 between the guide pin 111 and the guide pin 112. The guide pin 112 is slidably inserted and moved in a straight guide groove 121 extending from one end portion of a link lever 120, and a rotation shaft 122 of the foot mode door 62 is connected to the other end portion of the link lever 120.

When the link plate 71 is rotated by the driving of the actuator 70, the guide pins 81, 91, 92, 111, 112 are slidable in the guide grooves 73, 74, 101, 75, 121, respectively, so as to open and close the mode doors 60, 61, 62. The open degrees of the mode doors 60, 61, 62 are determined based on the angle degree (position) of the link plate 71.

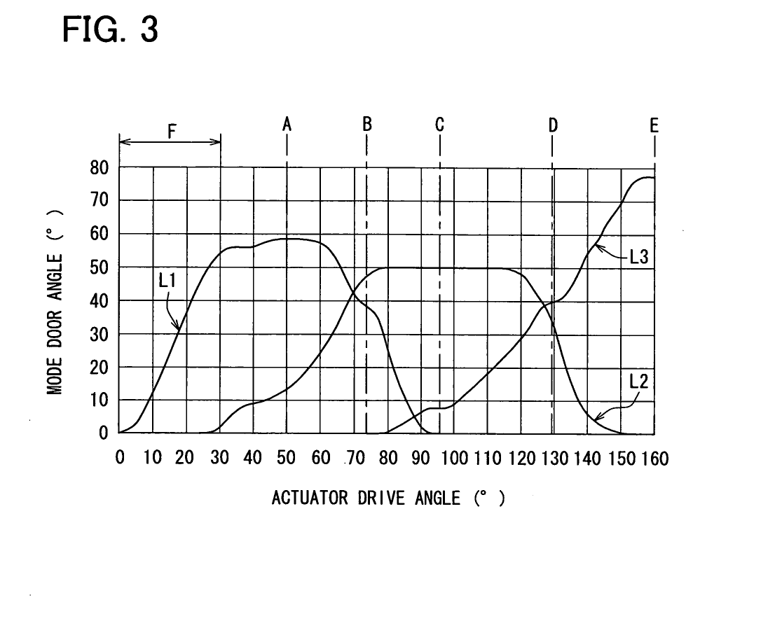

FIG. 3 is an example showing the relationship between an actuator drive angle (°) (i.e., the drive angle of the actuator 70) and a mode door angle (°) (i.e., the open degree of the mode doors 60, 61, 62). The drive angle (°) of the actuator 70 rotating clockwise in FIG. 2 is indicated as the positive in the abscissa axis of FIG. 2. Furthermore, in FIG. 3, graph L1 indicates the mode door angle of the face mode door 61, graph L2 indicates the mode door angle of the foot mode door 62, and graph L3 indicates the mode door angle of the defroster mode door 60. The mode door angles of the face mode door 61, the foot mode door 62 and the defroster mode door 60 are changed, respectively, in accordance with the graphs L1-L3, based on the drive angle (°) of the actuator 70.

As shown in FIG. 3, when the drive angle of the actuator 70 is about 50 degrees (°), that is, when the link plate 71 is at the angle position A, the angle of the face mode door 61 becomes maximum, and the face opening portion 51 is fully opened. When the drive angle of the actuator 70 is about 50 degrees (°), the angle of foot mode door 62 is not zero, however, the foot opening portion 52 is fully closed by the face mode door 61 positioned at the maximum angle as shown in FIG. 1. Furthermore, when the drive angle of the actuator 70 is about 50 degrees (°), the angle of the defroster mode door 60 is zero, and thereby the defroster opening portion is fully closed. Thus, when the link plate 71 is at the angle position A, a face mode is set as the air outlet mode so that conditioned air blown from the face opening portion 51 becomes maximum. For example, conditioned air is blown into the passenger compartment only from the face opening portion 51 in the face mode.

When the drive angle of the actuator 70 is about 73 degrees (°), that is, when the link plate 71 is at the angle position B, the face mode door 61 and the foot mode door 62 are rotated, respectively, to predetermined positions, and thereby the face opening portion 51 and the foot opening portions 52 are opened by predetermined middle open degrees. When the drive angle of the actuator 70 is about 73 degrees (°), the angle of the defroster mode door 60 is zero, and thereby the defroster opening portion 50 is fully closed. Thus, when the link plate 71 is at the angle position B, a bi-level mode is set as the air outlet mode so that conditioned air blown from both the face opening portion 51 and the foot opening portion 52 toward the upper and lower side in the passenger compartment.

As shown in FIG. 3, when the drive angle of the actuator 70 is about 96 degrees (°), that is, when the link plate 71 is at the angle position C, the angle of the face mode door 61 becomes zero, and the face opening portion 51 is fully closed. When the drive angle of the actuator 70 is about 96 degrees (°), the angle of foot mode door 62 becomes maximum, and thereby the foot opening portion 52 is fully opened. Furthermore, when the drive angle of the actuator 70 is about 96 degrees (°), the angle of the defroster mode door 60 is a low angle, and thereby the defroster opening portion 50 is opened by a small open degree. Thus, when the link plate 71 is at the angle position C, a foot mode is set as the air outlet mode so that conditioned air blown from the foot opening portion 52 becomes maximum. For example, conditioned air is blown into the passenger compartment only from the foot opening portion 52.

When the drive angle of the actuator 70 is about 130 degrees (°), that is, when the link plate 71 is at the angle position D, the angle of the face mode door 61 becomes zero, and thereby the face opening portion 51 is fully closed. When the link plate 71 is at the angle position D, both the foot mode door 62 and the defroster mode door 60 are rotated, respectively, to predetermined positions, and thereby the foot opening portion 52 and the defroster opening portions 50 are opened by predetermined middle open degrees. Thus, when the link plate 71 is at the angle position D, a foot/defroster mode is set as the air outlet mode so that conditioned air is blown from both the foot opening portion 52 and the defroster opening portion 50.

As shown in FIG. 3, when the drive angle of the actuator 70 is about 160 degrees (°), that is, when the link plate 71 is at the angle position E, the angles of both the face mode door 61 and the foot mode door 62 become zero, and thereby the face opening portion 51 and the foot opening portion 52 are fully closed. When the drive angle of the actuator 70 is about 160 degrees (°), the angle of the defroster mode door 60 becomes maximum, and thereby the defroster opening portion 50 is fully opened. Thus, when the link plate 71 is at the angle position E, a defroster mode is set as the air outlet mode so that conditioned air blown from the defroster opening portion 50 becomes maximum. For example, conditioned air is blown toward the windshield in the passenger compartment only from the defroster opening portion 50.

As described above, when the link plate 71 is moved from the angle position A to the angle position E, the air outlet mode is switched.

In the present embodiment, the guide grooves 73, 74, 75 are formed to have angle positions on a low angle side lower than the angle position A. A predetermined angle position range F on a lower angle side than the angle position A is used as a fluctuation control area in which the open degree of the face opening portion 51 is increased or decreased. For example, the predetermined position angle F is an actuator angle range between 0° and 30°. FIG. 2 shows a state of the link plate 71 at the lowest angle position (e.g., actuator drive angle=0°) within the angle position range F.

In the example of FIG. 3, the actuator 70 is rotated in one direction to have at least first to fifth drive angles in this order. For example, the first drive angle of the actuator 70 is about 0°, the second drive angle of the actuator 70 is about 30°, the third drive angle of the actuator 70 is about 50°, the fourth drive angle of the actuator 70 is about 73°, the fifth drive angle of the actuator 70 is about 96°.

When the link plate 71 is in the angle position range of F, the drive angle of the actuator 70 is in a range between 0° and 30°. When the drive angle of the actuator 70 is in a range between 0° and 30°, the rotation angle of the foot mode door 62 and the rotation angle of the defroster door 60 are approximately zero, so that both the foot opening portion 52 and the defroster opening portion 50 are substantially closed. On the other hand, the rotation angle of the face mode door 61 is increased from zero to approximately the maximum angle, as the drive angle of the actuator 70 increases from 0°. Therefore, when the drive angle of the actuator 70 is in a range between 0° and 30°, the open degree of the face opening portion 51 is changed between the fully close state and about fully open state while both the foot opening portion 52 and the defroster opening portion 50 are kept at the closed state.

For example, when the foot mode is set as the air outlet mode in a case where a passenger has a cooling request, the face opening portion 51 is fully opened and both the foot opening portion 52 and the defroster opening portion 50 are fully closed. Accordingly, conditioned air with a predetermined air amount is blown toward the upper body of a passenger on a front seat in the passenger compartment. Therefore, the temperature of the passenger compartment can be adjusted to be in a comfortable temperature range in which the passenger feels generally to be comfortable.

When the temperature of the passenger compartment is adjusted to be in the comfortable temperature range, the air amount to be blown into the passenger compartment from the face opening portion 51 is fluctuated by a relatively short period, thereby improving comfortable property for the passenger. That is, when the temperature of the passenger compartment is adjusted to be in the comfortable temperature range, a fluctuation control of the flow amount of the conditioned air is performed so that the comfortable property for the passenger can be improved. For example, the drive angle range between 0° and 30° of the actuator 70 is used as the fluctuation control area, and the drive angle of the actuator 70 is controlled by the control portion 130 to be increased and decreased within the drive angle range between 0° and 30° by a short period (e.g., several seconds-several dozen seconds). Accordingly, the open degree of the face opening portion 51 is increased and decreased by the short cycle while both the foot opening portion 52 and the defroster opening portion 50 are closed. Thus, even when the air amount blown from the blower unit is set at a constant value, the air amount blown toward the body of the passenger in the passenger compartment through the face opening portion 51 can be changed by a predetermined period.

In the fluctuation control of the flow amount of conditioned air, the drive angle of the actuator 70 can be changed by a regular cycle to be regularly increased and decreased. Alternatively, the drive angle of the actuator 70 may be changed by an irregular cycle to be irregularly increased and decreased. Alternatively, the drive angle of the actuator 70 may be continuously changed or discontinuously changed to be stopped at every predetermined time.

According to the present embodiment, after the temperature in the passenger compartment becomes in the comfortable temperature range, the fluctuation control of the flow amount of the conditioned air blown into the passenger compartment is performed, so that the comfortable property for the passenger in the passenger compartment can be improved. Furthermore, when the fluctuation control of the flow amount of conditioned air to be blown into the upper area of the passenger in the passenger compartment is performed, the comfortable property for the passenger in the passenger compartment can be further improved.

The drive angle of the actuator 70 that is used for switching the air outlet mode is increased and decreased by the relatively short cycle in the fluctuation control so that the flow amount of conditioned air to be blown into the passenger compartment is changed. Therefore, the fluctuation control in the flow amount of conditioned air to be blown into the passenger compartment can be performed without using an additional component such as an additional actuator. Thus, the cost for manufacturing the vehicle air conditioner 1 can be restricted even the vehicle air conditioner 1 is provided with the fluctuation control.

### Other Embodiments

Although the present invention has been fully described in connection with the preferred embodiment thereof with reference to the accompanying drawings, it is to be noted that various changes and modifications will become apparent to those skilled in the art.

In the above-described embodiment, the fluctuation in the flow amount of conditioned air blown into the passenger compartment via the face opening portion 51 is performed. However, the fluctuation control in the flow amount of conditioned air blown into the passenger compartment via the foot opening portion 52 may be performed. Furthermore, the fluctuation control in the flow amount of conditioned air blown into the passenger compartment via any air-outlet mode opening portion may be performed.

In the above-described embodiment, the flow amount of conditioned air to be blown via the face opening portion 51 is changed with the fluctuation during the face mode. However, the flow amount of conditioned air to be blown into the passenger compartment can be changed with the fluctuation during the bi-level mode by changing the drive angle of the actuator 70 with a short cycle (period). In this case, the fluctuation control is performed for both the flow amount of conditioned air blown toward the upper area of the passenger in the passenger compartment via the face opening portion 51 and the flow amount of conditioned air blown toward the lower area of the passenger in the passenger compartment via the foot opening portion 52.

In the above-described embodiment, the present invention is typically applied to a vehicle air conditioner in which the air conditioning is performed approximately similarly in the right area (driver's seat area) and the left area (front-passenger's seat area) in the passenger compartment. However. the present invention may be applied to a vehicle air conditioner in which the air conditioning are performed independently in the right area (driver's seat area) and the left area (front-passenger's seat area) in the passenger compartment.

In the above-described embodiment, the fluctuation control may be performed for the flow amount of conditioned air blown into the passenger compartment by changing a voltage applied to a blower motor of the blower unit by a predetermined cycle.

Such changes and modifications are to be understood as being within the scope of the present invention as defined by the appended claims.

What is claimed is:

1. An air conditioner for a vehicle, comprising:
air-outlet opening portions including a face opening portion through which conditioned air is blown toward an upper side of a passenger compartment of the vehicle, and a foot opening portion through which conditioned air is blown toward a lower side of the passenger compartment of the vehicle;
mode doors including a face mode door configured to open and close the face opening portion, and a foot mode door configured to open and close the foot opening portion;
a drive device configured to adjust open degrees of the mode doors; and
a control portion which controls operation of the drive device to perform a mode switching control in which the open degrees of the mode doors are adjusted based on an air outlet mode, and to perform a fluctuation control in which at least one of the face mode door and the foot mode door is increased or decreased in a predetermined range.

2. The air conditioner according to claim 1, wherein
the drive device includes a link mechanism configured to adjust the open degree of one of the face mode door or the foot mode door while closing the other one of the face mode door or the foot mode door, and an actuator configured to drive and operate the link mechanism.

3. The air conditioner according to claim 1, wherein
the actuator has at least first to fifth drive angles in this order when being rotated in one direction,
the link mechanism is configured to change the open degree of the face mode door while substantially closing the foot mode door when a rotation angle of the actuator is changed from the first drive angle to the second drive angle, configured to open the face mode door and to substantially close the foot mode door when the rotation angle of the actuator is at the third drive angle, configured to open both the face mode door and the foot mode door when the rotation angle of the actuator is at the fourth drive angle, and configured to substantially close the face mode door and to open the foot mode door when the rotation angle of the actuator is at the fifth drive angle, and
the control portion is configured to perform the fluctuation control by changing the rotation angle of the actuator in a range between the first drive angle and the second drive angle.

4. The air conditioner according to claim 1, wherein
the air-outlet opening portions further include a defroster opening portion through which conditioned air is blown toward an inner surface of a windshield of the vehicle,
the mode doors further include a defroster mode door configured to open and close the defroster opening portion, and
the control portion controls the operation of the drive device to perform the mode switching control in which the open degrees of the face mode door, the foot mode door and the defroster mode door are adjusted based on the air outlet mode, and to perform the fluctuation control in which at least one of the face mode door and the foot mode door is increased or decreased in the predetermined range.

5. The air conditioner according to claim 1, further comprising
a temperature adjustment portion provided upstream of the air-outlet opening portions so that the conditioned air having a desired temperature is blown into the passenger compartment through at least one of the air-outlet opening portions in a set air outlet mode,
wherein the control portion is configured to perform the fluctuation control while the conditioned air having the desired temperature is blown into the passenger compartment in the set air outlet mode.

6. The air conditioner according to claim 1, wherein the link mechanism is configured such that the mode doors are operatively linked with each other through the link mechanism.
